(19) United States
(12) Patent Application Publication
(10) Pub. No.: US 2012/0255452 A1
(43) Pub. Date: Oct. 11, 2012

(54) STRUCTURAL INKS

(76) Inventors: Christopher Lee Bower, Ely (GB); Phillip J. Coldrick, Ely (GB); Andrew Michael Howe, Cambridge (GB); Stephanie Veronique Desrousseaux, Arbonne (FR)

(21) Appl. No.: 13/391,012

(22) PCT Filed: Aug. 13, 2010
(86) PCT No.: PCT/US2010/002245

§ 371 Date: Jun. 26, 2012

(30) Foreign Application Priority Data
Aug. 21, 2009 (GB) 0914655.6

(51) Int. Cl. B41M 5/52; B41J 2/01; B05D 5/00; B41F 5/24

(52) U.S. Cl. 101/216; 347/100; 427/256; 428/32.11

(57) ABSTRACT

A composition comprising a plurality of discrete carrier-swellable polymer particles (preferably polyNIPAM particles) and a corresponding carrier (e.g. water), which particles have a low polydispersity index and are present in an amount of at least 0.1% by weight of the composition may be used to impart structural-image properties (such as structural colour) to a substrate by coating or printing methods. Additional benefits of adherence to low-energy surface substrates and enhanced rheological properties for printing compositions may also be provided. The compositions and methods used in the invention allow visual effects or security applications to be incorporated into substrates in a low-cost and convenient manner.

### FIELD OF THE INVENTION

The invention relates to speciality inks. In particular, the invention relates to the use of carrier-swellable polymer particles, such as microgel particles, in structural ink compositions, especially multifunctional inks, especially structural inks. The invention further relates to compositions comprising carrier-swellable polymer particles, such as microgel particles, the method of manufacture of such compositions and methods of printing using such compositions and their uses. The compositions of the present invention are suitable for printing or coating on various substrates but find particular application for printing on impermeable substrates.

### BACKGROUND OF THE INVENTION

Structural inks find utility in a range of applications. It is often desirable to be able to provide an indication of whether a product is authentic by using some security feature that is easily recognised and verified by the consumer. Holograms or colour change inks are one such means of providing this overt level of authentication. It is further desirable to differentiate consumer products from similar items by using unusual or eye catching visual effects on the packaging of the articles. In particular when similar articles of consumer goods are displayed side by side on a vendor's shelf, it is often such visual hooks that make the consumer choose one product in preference to another.

One way of introducing a special effect is via a microstructure of the appropriate dimensions to cause optical interference. A microstructure aligned in an array, for example the array of pits in a CD, behaves as a diffraction grating: the grating reflects different wavelengths in different directions due to interference phenomena, separating mixed “white” light into light of different wavelengths. If the structure is one or more thin layers then it will reflect some wavelengths and transmit others, depending on the layers' thickness. Microstructures formed in a pigmented system, such as an ink, may give optical effects in addition to the coloration provided by the pigment.

A challenge is how to introduce structural visual effects onto a substrate.

In U.S. Pat. No. 7,408,630, Nakamura et al describe a method of authenticating articles using colour-change inks in combination with retro-reflective coatings using an array of spherical particles as a lens so that an image or design is only visible when viewed along the direction of the illumination using a high intensity light source. However, the method has many steps, and requires several layers to be deposited in register. The colour-change ink is a liquid crystal based material that can only be deposited using a limited number of printing techniques, such as silk screen printing, to allow for the formation of the layered structure in the inks that give rise to the colour change effect.

WO-A-2008/076339 describes a method of creating structural colour using layered films of alginate and chitosan to create a Bragg reflector that has an angle dependent colour.

WO-A-2007/140486 describes a method of inkjet printing a metallic ink to create a differential reflective structure that has angle dependent intensity. WO-A-2006/013352 describes a method of creating angle-dependent optical effects by intaglio printing of raised periodic structures with different coloured land areas between the ridges.

EP-A-1653256 describes a method of creating monodisperse colloidal solutions in which the monodisperse spheres are coloured and can impart structural colour as a result of the ordered array created as the spheres pack together into a hexagonal lattice. These solutions can be dried to create coatings with colour-change properties; however the structures are prone to crack formation due to the large capillary forces pushing the spheres together as liquid drains from the ordered array. To avoid this issue, a pre-patterned substrate was used that locks the spheres into fixed positions and so prevents the capillary stress build up.

Sakiko Tsuji and Haruma Kawaguchi, Langmuir 2005, 21, 8439-8442, have demonstrated how microgel particles (swollen cross-linked polymer particles in which the degree of swelling is controlled by solvent affinity and extent of cross-linking) can be used to create a simple colour-change ink by control of the size and concentration of particles in the microgel composition resulting in the formation of single layer arrays of poly(N-isopropylacrylamide) (i.e. polyNIPAM) particles 400-700 nm in diameter with particle separations of 1200-1400 nm, by depositing very low (<0.001% wt/wt) concentrations of microgel onto a substrate.

In U.S. Pat. No. 4,627,689, Asher et al combined functionalised hydrogel polymers with monodisperse solid spheres of either polymer or inorganic material to create optical sensor devices that react to specific ions or analytes to give a visible colour change, due to a shift in the lattice spacing of the array.

WO-A-2008/075049 describes aqueous ink compositions comprising water-swellable particles, such as polyNIPAM, which demonstrate different rheological states at different temperature thereby enabling a low viscosity composition to pass through an inkjet print head to form a high viscosity droplet on contact with a substrate. Such inks are useful in inkjet printing onto impermeable substrates.

Whilst regular arrays are known for creating structural colour, there has not been demonstrated a reliable and accessible method of applying structural colour to a substrate.

The inventors have found that a carrier-swellable polymer particle composition, such as a microgel particle formulation, having a low polydispersity index and when provided in certain concentrations is capable of controllably imparting structural-image and structural-imaging properties onto substrates or to ink formulations.

### Problem to be Solved by the Invention

It is an object of the invention to provide a composition for coating or printing onto a substrate, especially a low surface energy or impermeable substrate, a means of providing structural-image properties and in particular angle-dependent structural colour in a straightforward and cost-effective manner.

It is a further object of the invention to provide a means for using such a composition in security and authenticity applications, especially in packaging applications, in a controllable manner.

It is a still further object of the invention to provide a multifunctional composition that is capable of providing the structural-imaging properties in addition to a further function, such as colour printing.

### SUMMARY OF THE INVENTION

According to the present invention there is provided the use of a composition comprising a carrier and a plurality of discrete carrier-swellable polymer particles in a concentration of at least 0.1% by weight of the composition, to impart structural-image properties to a substrate by applying said composition to said substrate in a manner that allows self-ordering of the particles on the substrate in areas of the substrate on which structural-image properties are desired.

In a second aspect of the invention, there is provided a structural-imaging composition comprising a carrier and a plurality of discrete carrier-swellable polymer particles in a concentration of at least 0.1% by weight of the composition, which composition is capable of providing a detectable structural image on printing of said composition onto a substrate.

In a third aspect of the invention, there is provided a substrate for printing comprising a low-energy and/or ink-impermeable surface, comprising a coating of carrier-swellable polymer particles, characterised in that the particles are formed in predetermined patterns of ordered particles and disordered particles such that a patterned structural image is formed on the substrate.

In a fourth aspect of the invention, there is provided a method of printing comprising the steps of: providing a printing composition comprising a carrier fluid and a plurality of discrete stimulus-responsive carrier-swellable polymer particles, which are characterised by having a first (swollen) state and a second (collapsed) state according to the presence of absence of a stimulus (or first functional parameter); providing a substrate for receiving the printing composition; providing to the substrate a patterning means for providing a pattern characterising areas of the substrate provided with and without a stimulus (or first functional parameter; and printing, via a printing means, the printing composition onto the substrate and allowing to dry to form a printed substrate in which ordered particles are provided on the substrate in a pattern according to the patterning means whereby structural-image properties are provided in said pattern.

### Advantageous Effect of the Invention

The method used in the invention overcomes the problem of creating a low-cost structural ink or structural-imaging composition having an angle-dependent image-forming property (e.g. colour) that may be used to authenticate or differentiate an article of goods. Such structural-imaging compositions (which may be multifunctional inks) have physical and rheological properties that allow printing or coating by existing methods, for example flexographic printing, gravure, screen, inkjet and pad printing, dip coating, doctor blade coating, rod coating, air knife coating, gravure and reverse-roll coating, slide coating, bead coating, extrusion coating, curtain coating and the like. The structural-imaging compositions used in the invention may be prepared as a clear composition with structural-image (e.g. structural colour) properties or may be formulated with a functional component such as a pigment to form a multifunctional ink. Alternatively, the composition may be used as an additive to conventional and commercial inks to impart structural-image properties to such compositions. In each case, they may be readily applied to a substrate by printing methods to provide a low-cost and convenient method of imparting structural-image, especially structural colour, properties to substrates.

### BRIEF DESCRIPTION OF THE DRAWINGS

FIG. 1 is a graph of microgel particle size (nm) against temperature (° C.) for a microgel composition produced according to Example 1.

FIG. 2 shows an atomic force microscopy topographic image of a PET substrate coated with a microgel-containing ink composition according to the present invention.

FIG. 3 shows a graph of printed line width (μm) against engagement (of a flexographic printing plate against a substrate) (μm) for each of a 10 μm and a 20 μm line on a PET substrate using each of a conventional UV curable flexographic printing ink and a microgel-containing ink according to the invention;

FIG. 4 shows an image of 10 μm and 20 μm width relief lines printed on a PET substrate using a conventional UV-curable flexographic printing ink at 60 μm engagement;

FIG. 5 shows an image of 10 μm and 20 μm width relief lines printed on a PET substrate using a microgel-containing ink according to the present invention at 60 μm engagement; and

FIG. 6 shows four samples of a biaxially orientated polypropylene substrate printed with an image using: a microgel-containing ink of the present invention with corona discharge treatment (FIG. 6a); a microgel-containing ink of the present invention without corona discharge treatment (FIG. 6b); a conventional UV-curable flexographic printing ink with corona discharge treatment (FIG. 6c); and a conventional UV-curable flexographic printing ink without corona discharge treatment (FIG. 6d).

### DETAILED DESCRIPTION OF THE INVENTION

The inventors have found that a structural-imaging composition can be prepared by dispersing a plurality of carrier-swellable polymer particles having a low polydispersity index (PDI) into a suitable carrier in an amount of at least 0.1% by weight of carrier-swellable polymer particles relative to the composition. In providing a sufficient concentration or laydown of such particles, the composition can be used in coating or preferably printing processes to impart structural-image properties to a substrate.

By structural-imaging composition, it is meant a composition, which on application to a substrate, is capable of imparting some structural-image property to the substrate. A structural-image property includes image characteristics arising from a structural property of the material coated or printed onto the substrate rather than from a colorant. Structural colour, in which colour is imparted to a substrate by the structural arrangement of particles on that substrate (rather than by means of a dye or pigment colorant), is an example of a structural-image property in the context of the present invention. Structural colour, in particular, is a structural-image property in which the arrangement of particles on a substrate according to a desired image are such that the structural image is formed that can be detected in the visible spectrum (e.g. by the naked eye). Structural-image properties may also include structural images formed which can only be detected by detecting radiation outside the visible spectrum (e.g. infra red or ultra violet).

Preferably, a structural-imaging composition according to the present invention is capable of imparting structural colour to a substrate to which it is applied.

Structural-image properties are formed on a substrate by the ordered arrangement of particle on the substrate. The composition of the present invention is characterised by self-ordering of particles on application to a substrate such that order is created and structural-image properties imparted. Without being bound by theory, it is believed that in imparting structural-image properties, carrier-swellable polymer particles when applied to a substrate in their swollen state in a composition of the present invention, tend to order themselves into a quasi-hexagonal close-packed arrangement as the coated or printed composition dries. This allows light or other radiation that is illuminated onto a substrate coated or printed with a composition of the present invention to exhibit angle-dependent colour or other imaging properties (e.g. detectable structure-related infra-red, ultraviolet or other wavelength image property). The wavelength at which the structure-related image can be seen is a characteristic of the particle size (and optionally of any gap between the particles). Accordingly, for visible spectrum structural-imaging properties (i.e. structural colour), carrier-swellable polymer particles having a size (in their dried, post-coated form) in the range of 380 to 750 nm may be used.

Preferably, the polydispersity index (PDI) of the particles after drying is 0.3 or less and more preferably 0.1 or less. PDI is defined in the ISO standard document 13321:1996E. A lower polydispersity index enables the particles on a coated or printed substrate to arrange themselves in a more ordered manner which is more conducive to producing structural-image properties.

The carrier fluid may be any suitable carrier fluid for the coating or printing process for which the composition is to be used. However, it is preferred that the carrier fluid is an aqueous liquid and that the composition is an aqueous composition.

By aqueous composition, it is meant that the solvent or carrier fluid comprises water in an amount of at least 50% by weight, preferably at least 75%, more preferably at least 90% and still more preferably at least 98%. A purely aqueous composition comprises a carrier fluid consisting essentially of water.

Preferably, the composition used in the invention further comprises a functional component, which is a component which imparts a further property (other than structural-image properties or structural colour) onto the composition or substrate. As such, the composition may then be termed a multifunctional composition. The functional component is a component comprising of a suitable functional material. A ‘functional component’ is a component or material for inclusion in the composition that may provide a particular desired mechanical, electrical, magnetic or optical property. As used herein the ‘functional component’ is preferably a colorant, such as a pigment, which is dispersed in a carrier fluid, or a dye, dispersed and/or dissolved in the carrier fluid, magnetic particles (e.g. for bar-coding), conducting or semi-conducting particles, quantum dots, metal oxide or wax. Preferably the functional component, however, is a pigment dispersed in the carrier fluid or a dye dispersed and/or dissolved in the carrier fluid.

The carrier-swellable polymer particulate material may be any suitable polymer composition which forms discrete particles in the carrier fluid (as opposed, for example, to a linear polymer material with significant multiple inter-polymer crosslinking) which polymer particulate material is compatible with the carrier fluid and preferably also other components of the composition, e.g. printing composition. In the case of aqueous carrier, the carrier-swellable polymer particulate is a water-swellable polymer particulate.

Preferably, the carrier-swellable polymer particulate material is a microgel. Any suitable microgel may be used noting that solvent-swellable microgels, ionic microgels and water-swellable microgels are known. More preferably the microgel is a water-swellable microgel.

The compositions used in the invention find particular application, especially as water-swellable microgels, for printing onto substrates that have low-energy surfaces and/or are impermeable.

The remainder of the disclosure herein may relate more particularly to microgels (or to carrier-swellable polymer particles) and in the context typically of water-swellable microgels for an aqueous printing system. However, the particular features discussed should be understood as applying also to the more general disclosure above where the context allows (or should be understood as further disclosing by implication the corresponding feature for a solvent-swellable particulate material). Likewise, the disclosure will tend to refer to a printing ink or flexographic printing ink, in the context of aqueous flexographic printing. However, where the context allows, the disclosure and in particular features discussed should be considered as applying to printing and coating compositions disclosed above in general.

As mentioned above, the carrier-swellable polymer compositions defined herein find particular utility in providing structural-image properties to substrates by coating or printing the composition onto the substrate and allowing the substrate to dry. It is believed that by providing sufficient amount and concentration of carrier-swellable polymer particles in the composition that their unique properties allow them to arrange themselves in quasi hexagonal close packed arrangement on the substrate and as the printed or coated composition dries. It is believed that when drying is complete, a quasi hexagonal close packed arrangement of particles remains, it is believed, adhered to the substrate surface in multi-layer arrangement. The regularity of the resulting dry particle array gives its structural-image properties, whereby for example light or other radiation irradiated upon the array in an angle dependent manner gives colour (in a manner that can be calculated according to Bragg's law, for example). The wavelength of the structural-image property produced and of the radiation required to generate such detectable image property depends, it is believed, upon the size of the in situ dry particle (in a close packed arrangement there are no particle gaps as such and the size of gaps in the array are a function of the size of the particles). The unique properties of the carrier-swellable polymer particles (such as microgels) enable this array of particles to form without cracking of the particles or the need to pre-format the substrate for arrangement of the particles.

Preferably, the composition comprises a carrier-swellable polymer particulate, e.g. microgel particulate, in an amount of from 0.1 to 50% by weight of the composition, more preferably from 1 to 40%, still more preferably at least 2%, still more preferably from 5 to 30% and most preferably from 10 to 25%.

The swellable particles, in situ in the composition according to the invention, preferably have a dry particle size defined by a mean diameter in the range 100 to 1500 nm and more preferably 200 to 800 nm. Since the particles in the composition used in the invention are carrier-swellable particles, their sizes in the swollen state can be, and typically are, significantly in excess of the dry particle size. The actual size of the carrier-swellable polymer particles in their swollen state in a carrier depends on a number of factors such as the affinity of the polymer to the carrier and the degree of crosslinking of the polymer, for example. Optionally, for example, the carrier-swellable polymer particles in their swollen state may be controlled to have diameter of 1.5× or greater the dried particle diameter, or 3× or greater the dried particle diameter or even 5× the dried particle diameter.

The carrier-swellable polymer particles, e.g. microgel particles, may be prepared by any suitable monomer units that will form the corresponding carrier-swellable polymer particles, typically by polymerisation, co-polymerisation, block polymerisation or otherwise.

Carrier-swellable polymer particles used according to the invention may alternatively be formed in other configurations than pure polymer particles capable of forming such microgels, which have the beneficial effect. As such, the carrier-swellable polymer particles may be formed, for example in a core-shell configuration in which carrier swellable polymers or oligomers are formed on a non carrier-swellable core, which may be a solid or porous core, whereby the core-shell configuration formed has microgel-like properties. In the case of an aqueous carrier, for example, water-swellable polymer or oligomers may be tethered or grafted onto a polystyrene or other hydrophobic core material.

Preferably, however, the carrier-swellable polymer particles, e.g. microgel particles, are not core-shell particles. Preferably, also, they do not comprise or are not formed from epoxy functional resins, e.g. polyepoxy functional resins such as diepoxy functional resin. It is preferred that the carrier-swellable polymer is formed by latex synthetic methods.

The composition used in the invention may be applied to a substrate by any suitable method. For example, it may be coated onto a substrate by any suitable coating method known in the art, such as, for example, dip coating, doctor blade coating, rod coating, air knife coating, gravure and reverse-roll coating, slide coating, bead coating, extrusion coating, curtain coating and the like. It may alternatively and preferably be applied to a substrate by a printing method. Such printing methods may include, for example, screen printing, lithographic printing, inkjet printing or flexographic printing. The choice of printing method depends in part upon the size of the particles in the composition, the nature of the substrate and the purpose. In using inkjet printing as the application method, for example, the size of polymer particles that may be used is limited by the size of particles that can pass through the inkjet head. Preferably, the composition is applied by flexographic printing as the preferred choice for high volume printing onto packaging materials. When applied by a printing method, the composition may comprise further components as would be typically required to enable printing by the chosen method. The composition may be considered then a printing composition and may further comprise, for example, certain surfactants or dispersants compatible with the carrier and particles which enhance the printability of the composition.

The composition may be applied to a substrate as a coating or according to a desired pattern.

Where the composition comprises a functional component, such as a pigment or dye, it preferably is applied by a printing method and according to the desired pattern of the pigment or dye. In this case, the multifunctional composition provides to the substrate both the printed ink message but also a structural-image property in the pattern of the printed ink message, which structural-image property may be view-angle dependent.

In this embodiment of the invention in which the composition comprises at least a carrier and a plurality of carrier-swellable polymer particles as described above, the composition may find a range of uses on application to a substrate including, for example, enhanced visual effects for packaging or security applications.

In using the composition for providing security capability to a substrate, the security capability (and thus the structural-image property) may be overt, covert or what we are referring to as securely covert. Overt structural-image properties are provided where the structural-image property can be viewed by the user in the visible spectrum without any special treatment (other than, for example, angle dependent viewing). Covert structural-image properties are such that can't be readily viewed by the user in the visible spectrum but require some form of treatment to enable them to be viewed. For example, it may be necessary to illuminate the coated or printed substrate in an angle dependent manner with a high intensity white light in order that the structural-image can be viewed by a user, for example in the visible spectrum. Alternatively, for example, it may be necessary to illuminate the coated or printed substrate with another source of radiation, such as UV light in order for the user to be able to see the visual effects of the structural-image. Securely covert structural-image properties are those that require a special device for detecting the structural-image properties. Typically, securely covert structural-image properties may require irradiation at a particular wavelength and detection of the resulting structural-image information at a particular wavelength outside the visible spectrum. Securely covert structural-image properties may be achieved by applying a composition comprising polymer particles having a dried particle diameter of 350 nm or less or 800 nm or greater.

Optionally, and according to a preferred embodiment of the invention, the carrier-swellable polymer particles or microgel particles are switchable (by which it is meant carrier-swellable particles or microgels of stimulus-responsive polymer) whereby the carrier-swellability is adjustable, due to some external change (switching function), between a first swollen (i.e. carrier retaining) state and a second unswollen state in the composition.

This first swollen (i.e. carrier-retaining) state may also be referred to as a ‘good solvent’ regime, whereby conditions are such that the carrier is a good solvent for the polymer particles causing the particles to retain carrier solvent and swell. In this first state, the viscosity of the composition at low shear is relatively high.

The switching function, to which switchable carrier-swellable polymer particles are responsive, may be selected (by careful selection of the monomers used to make the polymer particles) to be any suitable function such as temperature, pH, wavelength/intensity of light irradiated on the particles, electrical field, magnetic field, etc., or a combination thereof.

The switchable or stimulus-responsive carrier-swellable polymer particles in composition comprising the particles and a corresponding carrier, according to this embodiment, will be in its first state as defined above when the function (or stimulus function) to which it is responsive is at a first functional parameter and in its second state when the function is at a second functional parameter. In adjusting the quantity or amount of value of the function from a first functional parameter to a second functional parameter, the state of the polymer particles in the composition, as defined above, will change from the first to the second, and vice versa, at a switching parameter.

For example, if an azo moiety were included in the polymer in the composition, it may be possible to illuminate a portion on contact with the substrate according to a desired pattern in order to change its morphology. Alternatively, if the stimulus or switching function were pH, it may be possible to initially print the substrate according to a desired pattern with an ink or other composition having a pH above or below the switching parameter and apply the composition used in the invention, adjusted to have a corresponding pH below or above the switching parameter as required, whereby on application to the substrate structural-image properties are imparted according to the desired pattern. The skilled person would readily appreciate alternative forms of enabling a significant change in swellability in response to a number of external impetuses or stimuli to achieve the benefit of the invention.

Examples of such switchable or stimulus-responsive polymer particles are known in the art.

Preferably, the switching function is temperature, since this is readily externally controllable and variable. In a preferred embodiment, first temperature parameters are lower than the switching temperature, by which it is meant that the particles in the composition are in their first, swollen (i.e. carrier-retaining), state at temperatures below the switching temperature and second temperature parameters are higher than the switching temperature, by which it is meant that the particles in the composition are in their second (unswollen, e.g. collapsed) state at temperatures above the switching temperature.

A composition according to a preferred embodiment of the invention comprising stimulus-responsive or switchable carrier-swellable polymer particles (such as stimulus responsive microgels) and a carrier for said particles may be utilised to provide structural-image properties to a substrate to which it is applied in a number of ways. For example, it may be utilised to provide structural-image properties, such as structural colour, to the substrate according to a desired pattern by causing the substrate, or the composition as applied or to be applied to the substrate, to be subject to a first functional parameter according to the desired pattern of the structural-image properties and for those areas of the substrate that are non-pattern areas (i.e. areas of the substrate where to produce the pattern it is necessary that similar structural-image properties are not provided), or composition applied or intended to be applied to such areas, are subject to a second functional parameter. Such distinction between first and second functional parameters in pattern and non-pattern areas of the substrate may if maintained while the composition dries on the substrate result in desirable patterned structural-image properties on the substrate.

For example, in a preferred embodiment in which the particles are responsive to temperature in which the first temperature parameter (i.e. the first functional parameter where the function is temperature) is lower than the switching temperature and the second temperature parameter is higher than the switching temperature, a patterned structural image may be produced on the substrate by applying a composition comprising the particles to the substrate whilst the substrate is subject to patterns of heating and/or cooling. For example, the substrate may be held in contact with a patterned temperature controlled substrate (e.g. a patterned metal substrate in contact with a temperature-controlled platen) at a particular temperature above the switching temperature where the ambient temperature is below the switching temperature. In such circumstances, the dried composition in areas corresponding to contact with the metal plate would be unstructured whereas the non-contacted areas would be structured, thereby producing a corresponding pattern. Accordingly such patterned structural-image property carrying substrates may be produced by printing or coating such a composition onto a substrate in a roll-to-roll manner or successive sheet manner where the substrate is delivered via a temperature controlled patterned roller.

The composition of this embodiment may be applied to a substrate in a patterned or unpatterned manner by any suitable means, such as those coating and printing methods referred to above. The composition applied to a substrate may then optionally be arranged such that structural-image properties are provided according to a desired pattern by making use of a switchable property of the polymer particles mentioned above. Preferably, the composition is applied to a substrate by a printing method, which may be inkjet printing or flexographic printing, among others.

In one embodiment, the switchable carrier-swellable polymer particle composition of this embodiment is applied to or printed onto a substrate by inkjet printing. Typically, the size of the particles is limited by the size of the inkjet nozzle being used through which the particles should pass, which nozzle may have a diameter of, for example, up to 300 nm, more likely up to 150 nm and more likely still up to 100 nm. In order to enable the passage of particles through the nozzle, the selection of monomer and of the polymer particles and their manufacture and of the corresponding switching function should be such that the particles in the composition are in their second (unswollen) state at the operating conditions (e.g. temperature) of the inkjet printer, and more particularly the inkjet nozzle. The composition may be applied according to desired inkjet printed pattern or as a coating by inkjet printing. The conditions (e.g. temperature) of the substrate or patterned areas of the substrate may be such that the particles adopt their first (swollen) state in areas where structural-image properties are intended to be imparted to the substrate. Allowing the particle composition to dry with the particles in their first state is necessary for imparting the structural-image property to the substrate. Typically for passage of the particles through an inkjet nozzle, the particles, in their second (collapsed) state and correspondingly the dried particles on the substrate) are typically of a diameter of 300 nm or less, more preferably 150 nm or less and most preferably in the range 50 to 100 nm. The swollen particles in their first state as they should be provided on areas of the substrate to which structural-image properties are to be imparted may be significantly larger, typically at least 1.5× the collapsed particle diameter, more preferably at least 2× the collapsed particle diameter and optionally 3× the collapsed diameter or greater. On drying, the self-ordered particles typically return to their second state size such that dried particles on the substrate have a diameter of 300 nm or less, more preferably 150 nm or less and most preferably in the range 50 to 100 nm. Such arrangements produce structural-image properties. However, these properties are likely to be covert as they mostly fall outside the visible spectrum and more likely are securely covert as a special instrument would be required to detect the structural-image properties and they may have to be irradiated at a particular wavelength. Optionally, there may be provided to the inkjet printed composition a rigidity treatment by which the shrinkage of the particles (e.g. in their first state) during drying on the substrate can be controlled to be less than otherwise. The rigidity treatment would preferably be a crosslinking treatment which may be for example the treatment of the composition on the substrate with a crosslinking agent or irradiation of a composition of particles susceptible thereto with crosslinking irradiation, such as UV irradiation. Where the rigidity treatment is the provision of a crosslinking agent or activated crosslinker, this can be applied to the substrate according to a desired pattern prior to application of the composition to the substrate. The crosslinker may then react with the ordered particles to introduce rigidity into the particles and reduce the extent of shrinkage during drying. Alternatively, the rigidity treatment (e.g. application of a crosslinker or of irradiation such as UV radiation) may be conducted on the composition, after it has been printed onto the substrate, according to a desired pattern. By careful selection of the degree of crosslinking of the polymer particles in the composition and the second state particle size and by careful control of the degree of crosslinking initiated on the substrate, a method of imparting structural image properties to a substrate may be provided. Optionally, for example, according to this particular embodiment particles may in their second state have a diameter in the range of 150 nm or less and in their first state at least 600 nm and on drying 350-400 nm, whereby structural colour and an overt feature may be provided by an inkjet printing application method. The invention, therefore, further provides the use of an aqueous inkjet ink composition, as hereinbefore defined, especially in a continuous inkjet printing system, for printing onto a substrate, in particular an impermeable substrate, wherein the particles of the composition have a first state whereby the composition can pass through the orifice of an inkjet printhead and, in response to an external stimulus, a second state whereby the composition when jetted onto a surface is immobilised thereon and optionally treated with a post-printing rigidity treatment to minimize the shrinking of the particles during drying.

In applying a switchable composition, according to one example of this embodiment of the invention, to a substrate by inkjet printing, the polymer particle may be selected and formed such that at an operating temperature of the inkjet printhead of from 30 to 70° C., preferably 50 to 70° C. the composition is in its second (unswollen) state, whilst the areas of the substrate to which structural-image properties are to be applied may be maintained at temperatures of up to 25° C. (e.g. 18 to 25° C.) and preferably up to 50° C. (e.g. 25 to 50° C.) at which temperature the composition is in its first state (areas where no structural-image properties are required my alternatively remain unprinted or be held at a second temperature parameter).

The use of a rigidity treatment may furthermore be used to provide two or more structural images in any switchable carrier-swellable polymer particle composition, for example: a structural image of ordered particles having received post-printing rigidity treatment and a structural image of, smaller, ordered particles having not received the post-printing rigidity treatment.

In an alternative, and more preferred, embodiment, the switchable carrier-swellable polymer particle composition may be applied to or printed onto a substrate by flexographic printing. Preferably, according to this embodiment, the composition comprises particles with a mean particle size (in the second state and corresponding dried state) in the range 100 to 1500 nm and more preferably 200-800 nm. Preferably, during the printing process, the particles are in their first state (which may be, for example, at least 1.5× the second state particle diameter, more preferably at least 2× the second state particle diameter, still more preferably at least 3× and optionally at least 10× the second state particle diameter) since the rheological properties of the composition of particles in their first state enhance the printing attributes in flexographic printing. The conditions of the substrate (in terms of the switching function, e.g. temperature) may be controlled such that the particles in the composition as applied to the substrate are in their first state in areas of the substrate where ordered particles and hence structural-image properties are required. Optionally, the printed composition may be subject to post-printing rigidity treatment to control the degree of shrinkage of particles in their first state during drying on the substrate, which may optionally enable more than one structural-image property to be applied to a single substrate.

Optionally, the switching parameter may be defined as representing a range within which the swellability (and thus the particle diameter in the carrier) may adjust substantially and at least by an increase of diameter of 50% over the unswollen or collapsed (or dried) particle diameter). Preferably, the range of the switching parameter is as narrow as possible. For example, in the case of temperature as the switching function, the switching temperature is preferably a range of 2° C. or less, more preferably 1° C. or less. Where the switching parameter is a range, the state within that range may be defined as a transition state (in which the particles are changing from their first to their second state or vice versa). The transition state may be defined, for example, as the state during which particle size ranges, for example, from 1.1 times the average second state particle diameter to, for example, 1.5 times the average second state particle diameter (or other defined parameter) and the range of the switching parameter may also be defined accordingly. In this example, the second state may also be defined as that in which the average particle size does not differ by more than 10% from the average particles size at different functional parameters.

The compositions defined herein and their uses, in addition to providing structural-image properties to a substrate are particularly beneficial for use in applying functional components, such as dye or pigment, to a substrate that has low surface energy or is impermeable to the carrier. This is particularly the case for water-based inks and thus aqueous compositions according to the invention.

Carrier-swellable polymer particles and corresponding switchable carrier-swellable polymer particles in their first state are capable of providing certain rheological properties to compositions, such as ink compositions, that enhance printing properties. Most notably, is the ability to adhere to low surface-energy substrates and impermeable substrates, especially where the composition is an aqueous composition.

The composition used in the invention, in embodiments for application to low-energy surfaces or impermeable substrates, preferably has a viscosity (in the case of switchable particles, in its first state) at 0.01 Pa stress at 20° C. of at least 40 mPa·s, more preferably at least 50 mPa·s. Optionally, the viscosity in its first state is at least 100 mPa·s at the specified conditions.

Furthermore, in the case of flexographic printing as the means for applying the composition to the substrate, such a composition enhances the printability of a composition, especially onto low surface-energy and impermeable substrates, giving enhanced resolution without the need for corona discharge treatment. Still further, in an aqueous composition for flexographic printing, addition of a surfactant, such as SDS in an amount of greater than 1% by weight of the polymer material enhances the density in solid printed areas.

In the use of inkjet printing as the means for applying a switchable carrier-swellable polymer composition, the switchable nature means that the selection of the second state has a sufficiently low viscosity to allow passage of the composition, such as an ink composition, through the printhead whilst allowing the substrate adhesion properties and structural-image properties to be imparted by the composition's second state on the substrate.

In a preferred embodiment, the switching function is temperature.

The switching temperature can be fine-tuned to adapt to exterior conditions by appropriate selection of the stimulus-responsive polymer particles and/or by the inclusion/exclusion or adjustment of concentration of other components in the composition. However it is desirable that the viscosity change from a lower to higher viscosity and a concomitant volume change from a lower to a higher volume induced by the temperature change occur over as small a temperature range as possible. This increase in viscosity is preferably a factor of at least ten, preferably a factor of at least thirty, more preferably a factor of at least one hundred, and most preferably a factor of at least one thousand. The viscosity of the composition in an inkjet printhead will typically correspond to that determined at low shear while on the substrate the viscosity corresponds to that measured at low stress (for example 0.01 Pa).

It is preferred that at typical operating temperatures of flexographic printing the rheological properties of the printing composition associated with carrier-retaining/swollen polymer particles are retained. It is, therefore, preferred that the switching function (e.g. switching temperature or switching pH) is, or is adjusted to be, outside (typically above, in the case of temperature) the normal operating conditions (e.g. temperature, pH) of flexographic printing in order that the particles are present in their first swollen (carrier-retaining) state throughout the flexographic printing process.

Optionally, the composition may be provided as a coating prior to printing, which coating may have structural-image properties in its entirety or according to a pattern arising from the switching polymer being subject to variable conditions on the coated substrate. If coated onto a low surface-energy or impermeable substrate, to which such compositions may readily be adherable, the coated composition may, in addition to providing structural-image properties to the substrate, enable ready application of conventional pigment- or dye-containing inks which would otherwise not readily adhere to such a substrate. Maintenance of the structural properties of the coating may be enabled by applying a rigidity treatment after or during drying of the coating on the substrate.

In another aspect, a carrier-swellable polymer particle (or microgel particle) composition according to the present invention may be utilised as an addendum to provide structural-imaging properties to existing printing inks or commercially available inks. In this aspect, the carrier-swellable polymer particle (or microgel) composition may be incorporated into a printing ink (e.g. a flexographic ink) in any suitable proportion to achieve the reported effect, depending upon the precise nature of the printing ink, the substrate, the microgel particles themselves and the intended printing conditions.

A printing composition as a result of the incorporation of carrier-swellable polymer particle (or microgel) composition into a commercial flexographic printing ink preferably has a viscosity at 0.01 Pa stress at 20° C. of at least 40 mPa·s, more preferably at least 50 mPa·s. Optionally, the resulting printing composition has a viscosity at 0.01 Pa stress at 20° C. of 100 mPa·s or greater.

The number of monomer units in the carrier-swellable polymer particles used in the various embodiments of the invention may typically vary depending upon the size of the particles formed, as well as the nature and size of the monomers and the density of the polymer. For example, for particles from 200 nm to 2 μm, the number of monomers in a particle may vary within the range of 1500 k to 3,000,000 k, more typically 2500 k to 750,000 k, preferably 5000 k to 50,000 k. In some instances, for larger particles, a particle may comprise at least 25,000 k monomer units. For example, these ranges may apply where the monomer units are N-isopropylacrylamide and the particles range between 200 nm and 1 μm in the particles' second state (which may be referred to as the collapsed state) where the examples are stimulus responsive.

The carrier-swellable polymer/microgel particles may typically be prepared, for example, by polymerisation of monomers such as N-alkylacrylamides, such as N-ethyl-acrylamide and N-isopropylacrylamide, N-alkylmethacrylamides, such as N-ethyl-methacrylamide and N-isopropylmethacrylamide, vinylcaprolactam, vinyl methyl-ethers, partially substituted vinylalcohols, ethylene oxide modified benzamide, N-acryloylpyrrolidone, N-acryloylpiperidine, N-vinylisobutyramide, hydroxyalkylacrylates, such as hydroxyethylacrylate, hydroxyalkylmethacrylates, such as hydroxyethylmethacrylate, and copolymers thereof, by methods known in the art.

Optionally, polymer particles can also be prepared by micellisation of polymers and crosslinked while in micelles. This method applies to such polymers as, for example, certain hydroxyalkyl-celluloses, aspartic acid, carrageenan, and copolymers thereof.

The polymerization may be initiated using a charged or chargeable initiator species, such as, for example, a salt of the persulfate anion, or with a neutral initiator species if a charged or chargeable co-monomer species is incorporated in the preparation, the initial reaction between the initiator species and monomer molecules being initiated by light or heat.

Alternatively copolymers of the carrier-swellable polymer particles may be created by incorporating one or more other unsubstituted or substituted polymers such as, for example, polyacrylic acid, polylactic acid, polyalkylene oxides, such as polyethylene oxide and polypropylene oxide, polyacrylamides, polyacrylates, polyethyleneglycol methacrylate, polyvinyl alcohol, polyvinyl acetate, polyvinylpyrrolidone, polyvinyl chloride, polystyrene, polyalkyleneimines, such as polyethyleneimine, polyurethane, polyester, polyurea, polycarbonate or polyolefin.

Any polymeric acidic groups present may be partially or wholly neutralized by an appropriate base, such as, for example, sodium or potassium hydroxide, ammonia solution, alkanolamines such as methanolamine, dimethylethanolamine, triethylethanolamine or N-methylpropanolamine or alkylamines, such as triethylamine. Conversely, any amino groups present may be partially or wholly neutralized by appropriate acids, such as, for example, hydrochloric acid, nitric acid, sulfuric acid, acetic acid, propionic acid or citric acid. The copolymers may be random copolymers, block copolymers, comb copolymers, branched, star or dendritic copolymers.

Particularly preferred polymers for use in the preparation of the carrier-swellable polymer particles of the present invention are for example, a poly-N-alkylacrylamide, especially poly-N-isopropylacrylamide, and a poly-N-alkylacrylamide-co-acrylic acid, especially poly-N-isopropylacrylamide-co-acrylic acid, poly-N-isopropylacrylamide-co-polyethyleneglycol methacrylate, polyhydroxyalkylcellulose, especially polyhydroxypropylcellulose, polyvinylcaprolactam, polyvinylalkylethers or ethyleneoxide-propylene oxide block copolymers.

Generally a cross-linker may be required to maintain the shape of the polymer particle, although too high a concentration of cross-linker may inhibit the swellability of the polymer. If there is an alternative way of maintaining particle architecture, such as a core particle in a polymer shell; it may be possible in some instances, however, to exclude a cross-linker.

Suitable cross-linkers for this purpose include, for example, any materials which will link functional groups between polymer chains and the skilled artisan would choose a crosslinker suitable for the materials being used e.g. via condensation chemistry. Examples of suitable cross-linkers include N,N′-methylenebisacrylamide, N,N′-ethylenebisacrylamide, dihydroxyethylene bisacrylamide, N3N′ bis-acryloylpiperazine, ethylene glycol dimethacrylate, glycerin triacrylate, divinylbenzene, vinylsulfone or carbodiimides. The crosslinker may also be an oligomer with functional groups which can undergo condensation with appropriate functional groups on the polymer. The crosslinking material is used for partial crosslinking the polymer. The particles can also be crosslinked, for example, by heating or ionizing radiation, depending on the functional groups in the polymer.

The quantity of crosslinker used, if present, with respect to the major type of the monomer should normally be in the range of 0.01-20 mol % of crosslinker to monomer, preferably 0.1 to 1 mol % of crosslinker to monomer and more preferably 1 to 5 mol % of crosslinker to monomer although not specifically limited thereto. This is especially the case where the polymer formed comprises N-alkylacrylamide. The quantity of crosslinker will determine the crosslinking density of the polymer particles and may adjust, for example, the swelling degree and/or phase transition temperature (if it is a switchable polymer), of the polymer.

When printing, the quantity of a functional material contained in an ink composition, for example a colorant, is defined by the printing purpose. For example, the colorant concentration could be selected such that a so-called ‘dark’ or ‘light’ ink were produced, where ‘light’ refers to an ink formulation containing a lower concentration of colorant, of similar hue, to a ‘dark’ ink. It is preferable that the quantity of functional material, such as a colorant, namely pigment or dye, in an ink composition is from 0.1 wt % to 50 wt %, more preferably from 0.5 wt % to 30 wt %, still more preferably (especially for flexographic printing) from 1 wt % to 20 wt % and optionally from 2 wt % to 10 wt %.

Additional polymers, emulsions or latexes may be used in the inks of the present invention. Any homopolymer or copolymer can be used in the present invention, provided it can be stabilized in the carrier or medium of the composition (preferably an aqueous medium and so such homopolymer or copolymer may be generally classified as water-soluble, water-reducible or water-dispersible).

Although the composition (e.g. a multifunctional ink composition) is preferably primarily water-based, it may be suitable in some instances to include a small amount of an organic solvent, for example up to 10% of a solvent such as, for example, ethanol or methylethylketone to improve drying speed on the substrate. Preferably, however, the composition (e.g. multifunctional ink) is substantially free of organic solvent.

One or more humectants may be incorporated into the composition. Any inclusion of humectants should be at low concentration, preferably, for example, in an amount of up to 1% by weight, even in the range 0.1 to 0.5% by weight. However, it is preferred in the present invention, especially for printing on to impermeable substrates, that humectants are not included in the composition.

Surfactants may be added to the composition to adjust the surface tension to an appropriate level or to prevent aggregation of the polymer particulates. The surfactants may be anionic: for example, salts of fatty acids, salts of dialkyl-sulfosuccinic acid, salts of alkyl and aryl sulfonates; they may be nonionic: for example, polyoxyethylene alkyl ethers, acetylene diols and their derivatives, copolymers of polyoxyethylene and polyoxypropylene, alcohol alkoxylates, sugar-based derivatives; they may be cationic: such as alkylamines, quaternary ammonium salts; or they may be amphoteric: for example, betaines. However the surfactant should normally be selected such that it is either uncharged (non-ionic), has no net charge (amphoteric) or matches the charge of the polymer used. The most preferred surfactants include acetylene diol derivatives, such as Surfynol® 465 (available from Air Products Corp.) or alcohol ethoxylates such as Tergitol® 15-S-5 (available from Dow Chemical company). The surfactants can be incorporated at levels of 0.01 to 1% of the ink composition.

A biocide may be added to the composition employed in the invention to suppress the growth of microorganisms such as moulds, fungi, etc. in aqueous inks. A preferred biocide for the composition employed in the present invention is Proxel® GXL (Avecia Corp.) at a final concentration of 0.0001-0.5 wt %, preferably 0.05-0.5 wt %.

Additional additives which optionally may be present include thickeners (e.g. if it is necessary to enhance the thickening properties of the microgel particles), conductivity-enhancing agents, drying agents, anti-corrosion agents, defoamers and penetrants. In some instances it may be appropriate to include an additional binder, such as a styrene acrylic or polyurethane resin, to provide further robustness to the composition, but in most instances the binding properties of the carrier-swellable polymer (or microgel polymer) is likely to suffice.

The pH of aqueous ink compositions prepared in accordance with the invention may be adjusted by the addition of organic or inorganic acids or bases. Useful inks may have a preferred pH of from 2 to 11, preferably 7 to 9, depending upon the type of pigment or dye being used. Typical inorganic acids include hydrochloric, phosphoric and sulfuric acids. Typical organic acids include methanesulfonic, acetic and lactic acids. Typical inorganic bases include alkali metal hydroxides and carbonates. Typical organic bases include ammonia, triethanolamine and tetramethylethlenediamine.

In the compositions used in the invention which comprise a functional material (i.e. multifunctional compositions), the functional materials are preferably colorants (in which case they may be termed multifunctional inks) and may be dye or pigment based.

Pigment-Based Inks

Any suitable pigment according to the requirements of the application may be utilized in such multifunctional inks formed according to the present invention. The pigment inks may be made by any suitable method known to those skilled in the art.

The process of preparing inks from pigments commonly involves two steps: (a) a dispersing or milling step to break up the pigment to the primary particle, and (b) a dilution step in which the dispersed pigment concentrate from step (a) is diluted with a carrier and other addenda to a working strength ink. In the milling step, the pigment is usually suspended in a carrier (typically the same carrier as that in the finished ink) along with rigid, inert milling media. Mechanical energy is supplied to this pigment concentrate, and the collisions between the milling media and the pigment cause the pigment to disaggregate into its primary particles. A dispersant or stabilizer, or both, may be added to the dispersed pigment concentrate to facilitate disaggregation, maintain particle stability and, retard particle reagglomeration and settling.

Any suitable milling media may be used, including, for example, polymeric resin beads. Milling can take place in any suitable grinding mill. Suitable mills include an air jet mill, a roller mill, a ball mill, an attritor mill and a bead mill. A high-speed, high-energy mill is preferred by which the milling media obtain velocities greater than 5 m/s.

The dispersant is an optional ingredient used to prepare the dispersed pigment concentrate. Dispersants which could be used in the present invention include sodium dodecyl sulfate, acrylic and styrene-acrylic copolymers, such as those disclosed in U.S. Pat. Nos. 5,085,698 and 5,172,133 and sulfonated polyesters and styrenics, such as those disclosed in U.S. Pat. No. 4,597,794. Other patents referred to above in connection with pigment availability also disclose a wide variety of dispersant from which to select. Non-ionic dispersants could also be used to disperse pigment particles. Dispersants may not be necessary if the pigment particles themselves are stable against flocculation and settling. Self-dispersing pigments are an example of pigments that do not require a dispersant; these types of pigments are well known in the art.

The pigment particles useful in the invention may have any suitable particle size. The pigment particles, for example, may have a mean particle size of up to 0.5 μm. Preferably, the pigment particles have a mean particle size of 0.3 μm or less, more preferably 0.15 μm or less. A wide variety of organic and inorganic pigments, alone or in combination, may be selected for use in the inks of the present invention. Pigments that may be used in the invention include those disclosed in, for example, U.S. Pat. Nos. 5,026,427; 5,086,698; 5,141,556; 5,160,370 and 5, 169,436. The exact choice of pigments will depend upon the specific application and performance requirements, such as color reproduction and image stability.

Pigments suitable for use in the present invention include, for example, azo pigments, monoazo pigments, disazo pigments, azo pigment lakes, [beta]-Naphthol pigments, Naphthol AS pigments, benzimidazolone pigments, disazo condensation pigments, metal complex pigments, isoindolinone and isoindoline pigments, polycyclic pigments, phthalocyanine pigments, quinacridone pigments, perylene and perinone pigments, thioindigo pigments, anthrapyrimidone pigments, flavanthrone pigments, anthanthrone pigments, dioxazine pigments, triarylcarbonium pigments, quinophthalone pigments, diketopyrrolo pyrrole pigments, titanium oxide, iron oxide and especially carbon black.

Typical examples of pigments that may be used include Color Index (C. I.) Pigment Yellow 1, 2, 3, 5, 6, 10, 12, 13, 14, 16, 17, 62, 65, 73, 74, 75, 81, 83, 87, 90, 93, 94, 95, 97, 98, 99, 100, 101, 104, 106, 108, 109, 110, 111, 113, 114, 116, 117, 120, 121, 123, 124, 126, 127, 128, 129, 130, 133, 136, 138, 139, 147, 148, 150, 151, 152, 153, 154, 155, 165, 166, 167, 168, 169, 170, 171, 172, 173, 174, 175, 176, 177, 179, 180, 181, 182, 183, 184, 185, 187, 188, 190, 191, 192, 193, 194; C. I. Pigment Red 1, 2, 3, 4, 5, 6, 7, 8, 9, 10, 11, 12, 13, 14, 15, 16, 17, 18, 21, 22, 23, 31, 32, 38, 48:1, 48:2, 48:3, 48:4, 49:1, 49:2, 49:3, 50:1, 51, 52:1, 52:2, 53:1, 57:1, 60:1, 63:1, 66, 61, 68, 81, 95, 112, 114, 119, 122, 136, 144, 146, 147, 148, 149, 150, 151, 164, 166, 168, 169, 170, 171, 172, 175, 176, 177, 178, 179, 181, 184, 185, 187, 188, 190, 192, 194, 200, 202, 204, 206, 207, 210, 211, 212, 213, 214, 216, 220, 222, 237, 238, 239, 240, 242, 243, 245, 247, 248, 251, 252, 253, 254, 255, 256, 258, 261, 264; and CL Pigment Blue 1, 2, 9, 10, 14, 15:1, 15:2, 15:3, 15:4, 15:6, 15, 16, 18, 19, 24:1, 25, 56, 60, 61, 62, 63, 64, 66. In a preferred embodiment of the invention, the pigment is C.I. Pigment Black 7, C.I. Pigment Blue 15:3, C.I. Pigment Red 122, C.I. Pigment Yellow 155, C.I. Pigment Yellow 74, or a bis(phmalocyanylalumino)tetraphenyldisiloxane as described in U.S. Pat. No. 4,311,775.

Commercially used pigment preparations could also be used, such as the IDIS series of pigment dispersions by Evonik Degussa or the Hostafine series of pigment preparations of Clariant, such as HOSTAFINE Black TS, Blue B2G, Magenta E VP, Yellow GR (which uses Pigment Yellow 13) and Yellow HR (which uses Pigment Yellow 83), or the Hostajet series of pigment dispersions of Clariant, such as the PT and the ST series.

Particularly preferred pigments for use in this invention are, for example, PNB15-3 (cyan), PR122 (magenta), PY74 (yellow), IDIS 40 and especially Carbon K (black).

The pigment used in the ink composition used in the invention may be used in any effective amount, generally from 0.1 to 50 wt. %, preferably from 0.5 to 30 wt. %, more preferably 1 to 20 wt % and optionally 2 to 10 wt %.

Dye Based Inks.

Alternatively the colorants which could be used could be dyes including water-soluble dyes such as: CI Direct Black 2, 4, 9, 11, 17, 19, 22, 32, 80, 151, 154, 168, 171, 194, 199; C.I. Direct Blue 1, 2, 6, 8, 22, 34, 70, 71, 76, 78, 86, 112, 142, 165, 199, 200, 201, 202, 203, 207, 218, 236, 287; CL Direct Red 1, 2, 4, 8, 9, 11, 13, 15, 20, 28, 31, 33, 37, 39, 51, 59, 62, 63, 73, 75, 80, 81, 83, 87, 90, 94, 95, 99, 101, 110, 189; CI Direct Yellow 1, 2, 4, 8, 11, 12, 26, 27, 28, 33, 34, 41, 44, 48, 51, 58, 86, 87, 88, 132, 135, 142, 144; C.I. Acid Black 1, 2, 7, 16, 24, 26, 28, 31, 48, 52, 63, 107, 112, 118, 119, 121, 156, 172, 194, 208; C.I. Acid Blue 1, 7, 9, 15, 22, 23, 27, 29, 40, 43, 55, 59, 62, 78, 80, 81, 83, 90, 102, 104, 111, 185, 249, 254; C.I. Acid Red: 1, 4, 8, 13, 14, 15, 18, 21, 26, 35, 37, 52, 110, 144, 180, 249, 257, C.I. Acid Yellow 1, 3, 4, 7, 11, 12, 13, 14, 18, 19, 23, 25, 34, 38, 41, 42, 44, 53, 55, 61, 71, 76, 78, 79, 122; C.I. Reactive Red 23, 180; Reactive Black 31; Reactive Yellow 37; water soluble DUASYN dyes (from Clariant), water-soluble IRGASPERSE dyes (from Ciba). The dyes can be photochrome, thermochromic or fluorescent.

The support for the substrate used in the invention can be any suitable support usually used for the method of application or printing being adopted (e.g. for flexographic printing), but it is a particular advantage of the present invention that that it can be used for printing onto ‘low energy’ impermeable substrates, such as, for example, polyethylene and polypropylene. Normally printing onto low energy substrates often involves the use of corona discharge treatment or prior treatment with primers to enable good adhesion. It is a feature of this invention that such pretreatments are not usually necessary. Preferably, the method of printing may be carried out in the absence of corona discharge treatment. Although the composition of the present invention can also be used with permeable substrates, as detailed hereunder, printing onto non-porous substrates is especially preferred, and can also include substrates such as glass, diamond, borosilicates, silicon, germanium and metals such as aluminium, steel or copper. Accordingly high surface energy substrates may be beneficially printed using the carrier-swellable polymer particle-containing inks used in the invention. Optionally, for high-energy surface impermeable substrates, copolymer microgels may be used for enhanced adhesion.

Conventional substrates include, for example, resin-coated paper, paper, polyesters, or microporous materials such as polyethylene polymer-containing material sold by PPG Industries, Inc., Pittsburgh, Pa. under the trade name of Teslin®, Tyvek® synthetic paper (DuPont Corp.) and OPPalyte® films (Mobil Chemical Co.) and other composite films listed in U.S. Pat. No. 5,244,861. Opaque supports include plain paper, coated paper, synthetic paper, photographic paper support, melt-extrusion-coated paper and laminated paper, such as biaxially oriented support laminates. Biaxially oriented support laminates ate described in U.S. Pat. Nos. 5,853,965; 5,866,282; 5,874,205; 5,888,643; 5,888,681; 5,888,683 and 5,888,714. These biaxially oriented supports include a paper base and a biaxially oriented polyolefin sheet, typically polypropylene, laminated to one or both sides of the paper base. Polymeric supports also include cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthenate), poly(1,4-cyclo-hexanedimethylene terephthalate), poly(butylene terephthalate), and copolymers thereof; polyimides; polyamides; polycarbonates; polystyrene; polyolefins, such as polyethylene, polypropylene or polybutylene; polysulfones; polyacrylates; polyetherimides; polyvinyl chloride; polyvinylacetate; polyvinylamine; polyurethane; polyacrylonitrile; polyacetal; polytetrafluoroethene; polyfluorovinylidene; polysiloxane; polycarboranes; polyisoprene; rubber and mixtures thereof.

These materials can be coated or laminated onto other substrates or extruded as sheets or fibres; the latter can be woven or compressed into porous but hydrophobic substrates, such as Tyvek®, and mixtures thereof. The papers listed above include a broad range of papers, from high end papers, such as photographic paper, to low end papers, such as newsprint.

When the support used in the invention is a paper support, it may have a thickness of from 50 to 1000 μm, preferably from 75 to 300 μm. Antioxidants, antistatic agents, plasticizers and other known additives may be incorporated into the support, if desired.

Whilst the composition used in the invention avails the user of the option to neglect a corona discharge step, the option of conducting a corona discharge step in order to improve the adhesion of an ink-receiving substrate surface remains. Known coating and drying methods are described in further detail in Research Disclosure no. 308119, published December 1989, pages 1007 to 1008. Research Disclosure is a publication of Kenneth Mason Publications Ltd., Dudley House, 12 North Street, Emsworth, Hampshire PO 107DQ5 United Kingdom. After printing, the ink is generally dried by simple evaporation, which may be accelerated by known techniques such as convection heating. Any further post-printing coating composition can be coated either from water or organic solvents, however water is preferred. The total solids content should be selected to yield a useful coating thickness in the most economical way.

### EXAMPLES

### Example 1

A microgel composition was prepared using; 7.9 g of N-isopropylacrylamide (NIPAM), 0.151 g of methylenebisacrylamide (BIS), 0.256 g potassium persulfate (KPS) and 460 g of water. In a 1 litre double-wall glass reactor with mechanical stirring, refrigerant and N₂ inlet, the NIPAM was added to half the BIS at a reactor temperature of 40° C. After stirring the solution at 200 rpm and purging with N₂ for 1 hour, the temperature was increased to 70° C. The KPS was dissolved in 10 ml deionised (DI) water at room temperature. The other half of the BIS (0.0755 g) was also dissolved in 10 ml DI water. The KPS initiator solution was poured into the reactor in one shot. The BIS solution was added into the reactor dropwise over the next 30 minutes. The dispersion was mixed for 6 hours then left to cool overnight at room temperature. The dispersion was filtered on filter paper to remove TEFLON residues from the stirrer bar using a Buchner filter with pump and then purified by dialysis against DI water until conductivity was below 5 microS/cm.

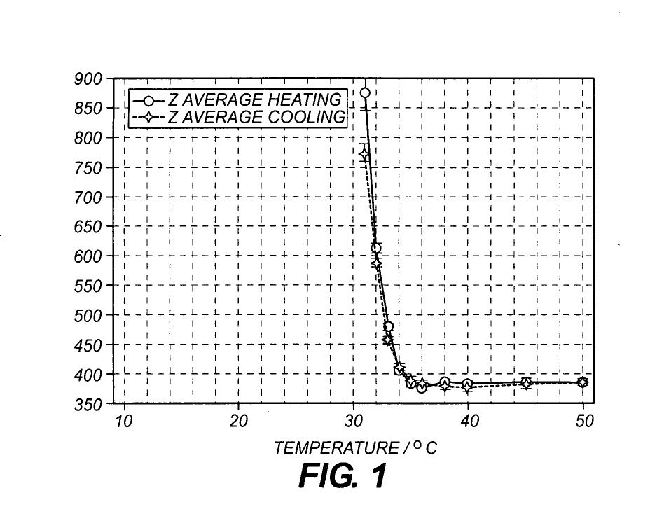

The particle size of the suspension of these thermally-sensitive particles was measured by photon correlation spectroscopy, PCS, and determined with a Malvern ZETASIZER NANO ZS. A dilute sample of thermally-sensitive particles was obtained from the purified sample and was diluted with milli-Q water, a typical sample concentration being 0.05 wt %. Samples were equilibrated at each temperature for 10 minutes and then the size was measured 5 times, such that the total time at each temperature was approximately 25 minutes. The results quoted are the mean of the measurements. The hydrodynamic diameter was measured as 383 nm at 50° C. and 610 nm at 32° C., but cannot be measured below this temperature as the fully swollen size is above 1 micron and outside the measurement range of the apparatus. FIG. 1 shows a graph of particle size (nm) against temperature (° C.) according to the above microgel particle measurements.

An aqueous printing ink was formulated using 4% microgel composition, 6% carbon black pigment, IDIS 40 (Evonix), 0.19% SURFYNOL 104 (Air Products) and 1.2% sodium dodecyl sulfate (SDS, Fluka). The ink was mixed by rolling on ball mill for several hours.

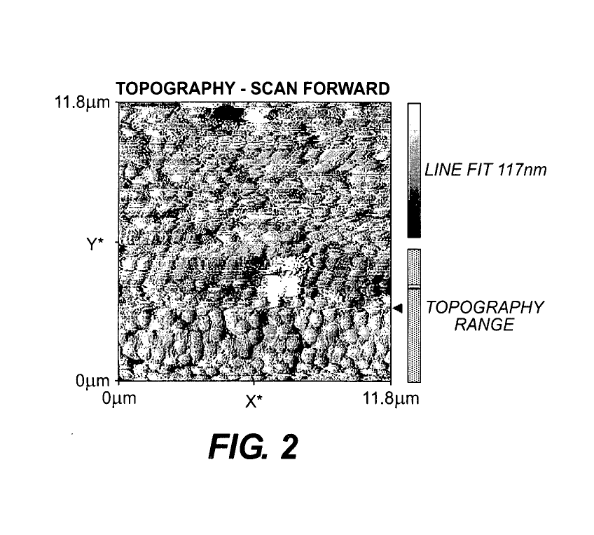

The ink was flexographically printed onto PET substrate using an EASI PROOF flexographic printer (RK Print Ltd. Royston) to print large areas of solid ink, and a FLEXOTESTER (RK Print Ltd. Royston) fitted with a Kodak FLEXCEL plate to print text, images and solid regions of ink. The printed samples appeared black when viewed under ambient light. However when viewed with a bright white light source such as an ultrabright white LED or halogen light source, low angle illumination revealed strong angle-dependent structural colour effects due as a result of the ordered array of microgels in the sample. AFM images of the sample confirmed that this was indeed the case, with quasi-hexagonal arrays of microgels having a mean diameter of approximately 650 nm found to be present in the dried ink sample, as shown in FIG. 2. The colour was also found to be retro-reflective since it was only visible along the direction of the incident bright white light source.

### Example 2

### Comparative Example

An aqueous printing ink was formulated using 4% un-crosslinked N-isopropylacrylamide (NIPAM), 6% carbon black pigment, IDIS 40 (Evonix), 0.19% SURFYNOL 104 (Air Products) and 1.2% sodium dodecyl sulfate (SDS, Fluka). The ink was mixed by rolling on ball mill for several hours. The ink was flexographically printed onto PET substrate using an EASI PROOF flexographic printer (RK Print Ltd. Royston) to print large areas of solid ink, and a FLEXOTESTER (RK Print Ltd. Royston) fitted with a Kodak FLEXCEL plate to print text, images and solid regions of ink. The printed samples appeared black when viewed under ambient light. No structural colour effects were visible when viewed with a bright white light source such as an ultrabright white LED or halogen light source.

### Example 3

This example relates to the addition of a microgel composition to a commercial ink to give angle-dependent colour effect showing additive effect.

5 mL of the microgel composition prepared according to Example 1 was added to a sample of JONCRYL FLX5000 aqueous flexographic ink (BASF) and mixed on a ball mill by rolling for several hours, to give a flexographic ink with a microgel concentration of ˜4% w/w. This modified ink was printed with an EASI PROOF flexographic printer (RK Print Ltd. Royston) to print large areas of solid ink onto PET substrate. The resulting image had a similar optical density to a sample printed under the same conditions without the microgel addition. However the sample containing the microgel was seen to exhibit angle dependent colour when illuminated with a high intensity white light source

### Example 4

This example demonstrates the use of temperature to create covert structural colour images.

A multifunctional colour change ink was formulated as in example 1. The multifunctional ink was flexographically printed onto a sample of PET held in contact with a patterned metal substrate in contact with a temperature-controlled platen held at 37.5° C. The patterned metal substrate had a series of rectangular holes approximately 2 mm×10 mm, so that when it was held in contact with the heated platen, the regions of the PET above the rectangular holes were cooler than the other regions of the PET in contact with the metal regions. The printed ink layer appeared black when viewed under ambient light. However, when viewed with high intensity white light, angle-dependent structural-colour was clearly visible but only in the rectangular regions of the ink that corresponded to the cooled regions on the PET substrate.

### Example 5

This demonstrates structural colour formation on drying a printed substrate at low temperature.

A multifunctional colour-change ink was formulated as in example 1. The multifunctional ink was flexographically printed onto a sample of PET at a temperature of 18° C., using the EASI PROOF device described in Example 1. The printed ink layer appeared black when viewed under ambient light, however, when viewed with high intensity white light, angle-dependent structural colour was clearly visible throughout the entire sample.

### Example 6

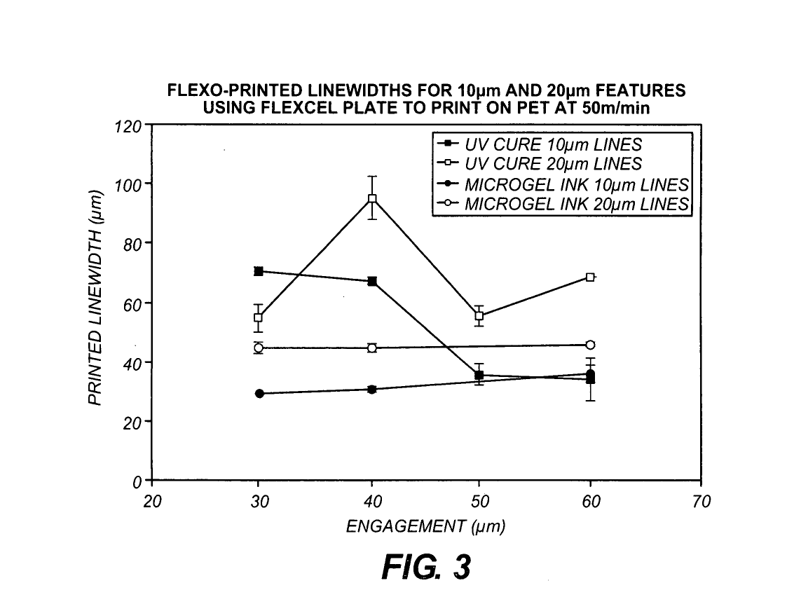

An ink was formulated as in Example 1. The ink was flexographically printed onto a sample of PET using an RK FLEXIPROOF 100 (RK Print Ltd., Royston). A Kodak FLEXCEL plate was mounted on the FLEXIPROOF using two layers of rigid double sided plate mounting tape to ensure the correct plate thickness. The anilox was a ceramic, laser engraved 800 lpi. All experiments were performed at ambient temperature which was approximately 18-20° C. Substrate speed was 50 m/min. The point of kiss contact and optimum pressures were determined using Flexocure GEMINI (Flint inks) UV-curable ink since it does not dry. The effects of different levels of engagement pressure on the printed line width were investigated (where kiss contact is at 0 μm engagement). FIG. 3 shows a comparison of the printed line width for both 10 μm and 20 μm wide lines on the plate, using both the UV-curable ink and the microgel-containing ink. It is clear from the Figure that the line widths are lower and more consistent at all levels of engagement, using the multifunctional ink compared to the UV-curable ink.

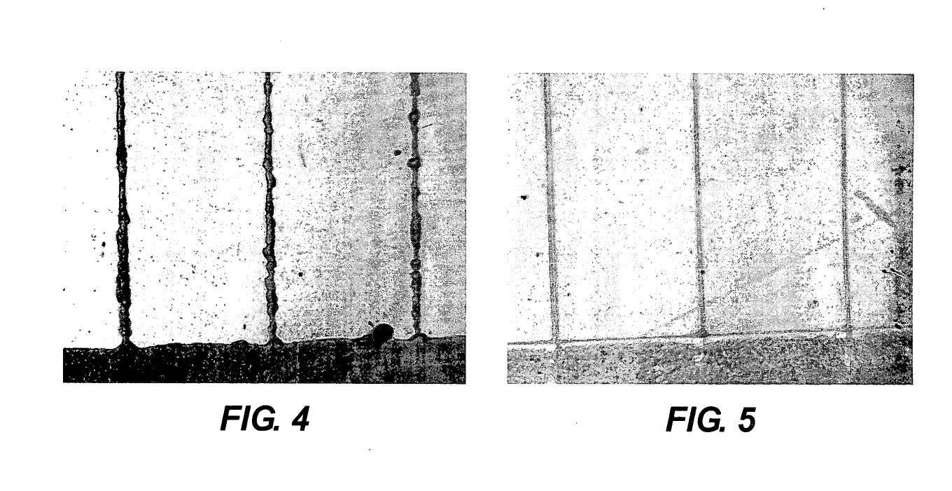

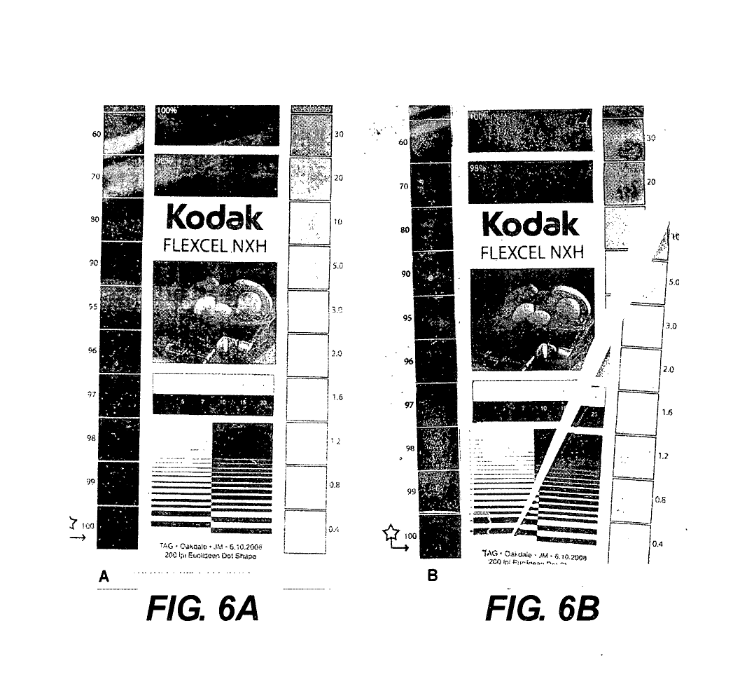

FIG. 4 shows images of the 10 μm and 20 μm features printed with the UV-curable ink at 60 μm engagement and FIG. 5 shows the comparable lines printed with the aqueous microgel-containing ink. It is clear that the lines printed with the microgel-containing ink are sharper, more consistent and have much straighter edges compared to those printed with the UV-curable ink.

### Example 7

### Printing on Untreated Hydrophobic Surfaces

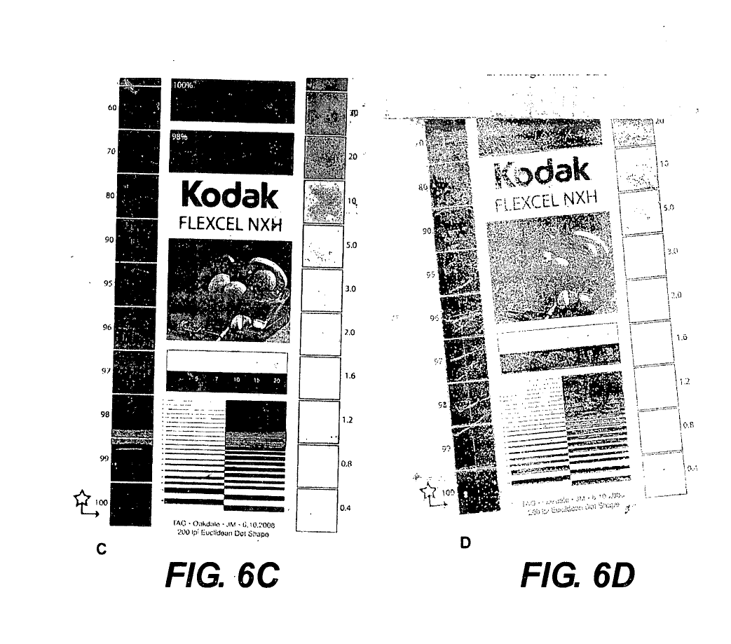

An ink was formulated as in Example 1. The ink was flexographically printed onto both sides a sample of biaxially orientated polypropylene (BOPP) (RAYOFACE W28 supplied by Innovia Films) using an RK FLEXIPROOF 100 (RK Print Ltd., Royston). The substrate had been treated with a corona discharge on one side to raise the surface energy and improve the adhesion, but was untreated on the other side. A Kodak FLEXCEL plate was mounted on the Flexiproof using two layers of rigid double sided plate mounting tape to ensure the correct plate thickness. The anilox was a ceramic, laser engraved 800 lpi. All experiments were performed at ambient temperature which was approximately 18-20° C. Substrate speed was 50 m/min. As a comparison, both the treated and the untreated sides of the BOPP substrate were printed with UV-curable ink (Flexocure Gemini, Flint inks). The four printed samples are shown in FIG. 6.

In FIG. 6, samples of BOPP are shown printed with microgel-containing ink and UV-curable ink on both the CDT treated and untreated sides. FIGS. 6A to 6D are as follows. A: Microgel ink on CDT treated BOPP, B: Microgel ink on BOPP with no CDT treatment, C: UV-curable ink on CDT treated BOPP, D: UV-curable ink on BOPP with no CDT treatment.

It is clear from the comparison between FIGS. 6A and 6B (which show respectively the microgel-containing ink printed on a substrate which has been subject to corona discharge treatment and on a substrate which has not been subject to corona discharge treatment) that adhesion of the printed microgel-containing ink onto the low-energy substrate is very good whether or not the substrate has been treated with a corona discharge, the untreated surface only marginally less consistent. In comparing the UV-curable ink printed respectively on the corona discharge treated surface (FIG. 6C) and the untreated surface (FIG. 6D), it is clear that the UV-curable ink adheres very poorly to an untreated surface as compared with a treated surface. Furthermore, the untreated surface has much better printed characteristics when printed with a microgel-containing ink as compared with the UV-curable ink (compare FIGS. 6B and 6D).

### Example 8

### Effect of Microgel Size on Optical Properties

A microgel was synthesised in a 1-L double-wall glass reactor with mechanical stirring, a refrigerant and a nitrogen inlet, 900 ml of milli Q water, 15.8 g of N-Isopropylacrylamide (NIPAM), 0.304 g of Methylenebisacrylamide (BIS) and 0.306 g of Sodium Dodecyl Sulphate (SDS) were mixed. This monomer solution was stirred @200 rpm, heated at 40° C. and degassed for 1 hour 15 minutes by bubbling through with nitrogen.

The temperature of the reaction mixture was then increased to 70° C. (over 15 minutes) and allowed to degas under nitrogen. Separately, 0.606 g of potassium persulfate (KPS, ground) was solubilized @ room temperature in 10.1 ml DI water. When all the initiator was solubilised, the solution was degassed with argon for 5 minutes. The initiator solution poured rapidly into the reactor and the mixture was stirred @200 rpm at 70° C. for 6 hours under nitrogen. Very rapidly the solution became blue opalescent and then white. The mixture (405.9 g) was concentrated under vacuum (25 mmHg) in 2 h at 50° C., in 2 fractions: 119.4 g of water was removed from fraction I (208.5 g); 135.9 g of water was removed from fraction II (197.4 g). The 2 fractions were then mixed (hot fraction II was poured into lukewarm fraction I). 142.1 g of a liquid, viscous at RT, was obtained. In this case the mean size of the microgel particles was 283 nm at 20° C. and 119 nm at 50° C. The resulting concentration was 5.4% wt/wt and at room temperature was strongly iridescent due to the formation of a quasi-hexagonal close-packed array of monodisperse microgel particles with a mean size around 200 nm. A printing ink was formulated using 4% microgel, 6% carbon black pigment, IDIS 40 (EVONIX), 0.19% SURFYNOL 104 (Air Products) and 1.2% sodium dodecyl sulfate (SDS, Fluka). The ink was mixed by rolling on ball mill for several hours. The ink was flexographically printed onto PET substrate using an EASI PROOF flexographic printer (RK Print Ltd., Royston) to print large areas of solid ink, and a FLEXOTESTER (RK Print Ltd. Royston) fitted with a Kodak FLEXCEL plate to print text images and solid regions of ink. The printed samples appeared black when viewed under ambient light. Even when viewed with a bright white light source such as an ultrabright white LED or halogen light source, there was no evidence of structural colour in the visible spectrum, since the dried size of the microgels was too small to be seen by the naked eye (i.e. structural-image properties were outside the visible spectrum).

It will be understood that the descriptions above are examples to illustrate the invention only and that many more applications fall within the scope of the claims.

1. A method of printing comprising:
providing a printing composition comprising a carrier and a plurality of discrete stimulus-responsive carrier-swellable polymer particles in a concentration of at least 0.1% by weight of the composition, which are characterised by having a first (swollen) state and a second (collapsed) state according to the presence of or absence of a stimulus;
providing a substrate for receiving the printing composition; and
imparting structural-imaging properties to the substrate by applying said composition to said substrate in a manner that allows self-ordering of the particles on the substrate in areas of the substrate on which structural-imaging properties are desired, wherein the substrate is provided with a switching function according to a pattern of structural-imaging desired for the substrate, whereby on application of the composition to the substrate pattern of particles in the first (swollen) state and in the second (collapsed) state are provided according to where the switching function is present and absent.

2. A method as claimed in claim 1, wherein the plurality of discrete carrier-swellable polymer particles has a polydispersity index of 0.3 or less.

3. A method as claimed in claim 2, wherein the plurality of discrete carrier-swellable polymer particles has a polydispersity index of 0.1 or less.

4. A method as claimed in claim 1, wherein the composition further comprises a functional component.

5. A method as claimed in claim 4, wherein the functional component is a dye or pigment and wherein the method further comprises applying a printed image to the substrate according to a desired printed pattern.

6. A method as claimed in claim 1, wherein the carrier is aqueous.

7. A method as claimed in claim 1, wherein the carrier-swellable polymer particles are microgel particles.

8. A method as claimed in claim 1, wherein the carrier-swellable polymer particles comprise polyN-isopropylacrylamide or N-isopropylacrylamide-containing co-polymer.

9. (canceled)

10. A method as claimed in claim 1, wherein the switching function is temperature and wherein the switching parameter is a switching temperature.

11-12. (canceled)

13. A method as claimed in claim 1, wherein the carrier-swellable polymer particles have a particle diameter in their second (collapsed) state in the range 100-1000 nm.

14. A method as claimed in claim 1, in which the composition is applied to the substrate by flexographic printing.

15. A method as claimed in claim 1, in which the composition is applied to the substrate by inkjet printing.

16. (canceled)

17. A method as claimed in claim 1, wherein the concentration of the carrier-swellable polymer particles is in the range from 1 to 20 wt % of the composition.

18-20. (canceled)

21. A method as claimed in claim 22, wherein the aqueous composition is a flexographic printing composition.

22. A method of printing comprising:
providing an aqueous composition comprising a carrier and a plurality of discrete carrier-swellable polymer particles having a dried particle size of at least 100 nm and in a concentration of at least 0.1% by weight of the composition, which composition is capable of providing a detectable structural image on printing of said composition onto a substrate:
providing a low surface energy and/or impermeable substrate;
pre-treating the a low surface energy and/or impermeable substrate to provide a structural-imaging security feature-by applying a coating of the composition to the substrate whereby a structural-image is formed according to a pre-determined pattern; and
printing the pre-treated substrate with an aqueous ink.

23. A substrate for printing comprising a low-energy and/or ink-impermeable surface, comprising a coating of carrier-swellable polymer particles, characterised in that the particles are formed in predetermined patterns of ordered particles and disordered particles such that a patterned structural image is formed on the substrate.

24. (canceled)

25. A substrate as claimed in claim 23, wherein the coating further comprises a cross-linker whereby the particles retain their shape and/or adhesion to the substrate when re-wetted during subsequent printing processes.

26. A method of printing comprising the steps of:
providing a printing composition comprising a carrier fluid and a plurality of discrete stimulus-responsive carrier-swellable polymer particles, which are characterised by having a first (swollen) state and a second (collapsed) state according to the presence of or absence of a stimulus;
providing a substrate for receiving the printing composition;
providing to the substrate a patterning means for providing a pattern characterising areas of the substrate provided with and without a stimulus; and
printing, via a printing means, the printing composition onto the substrate and allowing to dry to form a printed substrate in which ordered particles are provided on the substrate in a pattern according to the patterning means whereby structural-image properties are provided in said pattern.

27. A method as claimed in claim 26, wherein the printing composition is a flexographic printing composition.
